(19) United States
(12) Patent Application Publication
(10) Pub. No.: US 2011/0163219 A1
(43) Pub. Date: Jul. 7, 2011

(54) LAPTOP TRAY FOR ROLL-ABOARD LUGGAGE

(76) Inventor: Kenneth R. Sperry, Edmond, OK (US)

(21) Appl. No.: 12/986,600

(22) Filed: Jan. 7, 2011

Related U.S. Application Data
(63) Continuation-in-part of application No. 12/678,554, filed on Mar. 17, 2010.
(60) Provisional application No. 61/292,973, filed on Jan. 7, 2010.

(51) Int. Cl. F16M 13/02

(52) U.S. Cl. 248/447.2

(57) ABSTRACT

An apparatus for supporting a laptop computer includes a generally rectangular support body having a pair of spaced apart longer parallel side rails connected by a bottom rail and a top rail, the bottom rail extending above a plane of the side rails to form a support surface for an object resting on the side rails, and a handle attached to the top rail for releasably engaging an extending handle assembly attached to a roll-aboard luggage bag. The handle can include a fixed jaw attached to the top rail, a threaded rod attached to the fixed jaw, a movable jaw mounted on the rod, and a knob threadably engaging the rod for moving the movable jaw toward the fixed jaw.

### CROSS-REFERENCE TO RELATED APPLICATION

This application is a continuation-in-part of the co-pending U.S. patent application Ser. No. 12/678,554 filed Mar. 17, 2010.

This application claims the benefit of U.S. provisional patent application Ser. No. 61/292,973 filed Jan. 7, 2010.

### FIELD OF THE INVENTION

The present invention relates generally to an apparatus for supporting a laptop computer.

### BACKGROUND OF THE INVENTION

The modern business traveler often finds himself or herself waiting for transportation or an appointment. Such traveler typically carries a portable computer that can be used to perform work tasks during the waiting period. However, waiting areas in airports, train stations and office lobbies usually do not have a desk-like surface for supporting the portable computer in a comfortable working position.

A portable work surface for use with a luggage carrier is shown in U.S. Pat. No. 6,150,508 issued Aug. 22, 2000. A ground engaging leg and an engaging apparatus are attached to the work surface. The engaging apparatus frictionally couples to a support member of the luggage carrier.

A combined desk and luggage carrier is shown in U.S. Pat. No. 6,543,796 issued Apr. 8, 2003. A wheeled luggage supporting frame has a pivotally connected lower support shelf on one side and a pivotally connected upper desk-top shelf on an opposite side. Folding telescopic legs are attached to the desk-top shelf for further support.

U.S. Pat. No. 6,604,472 shows a tray having either a foldable leaf portion or a fixed upstanding rib. The tray rests on top of the upright luggage with the leaf portion or rib engaged with a handle of the luggage to maintain the tray in a horizontal position.

### SUMMARY OF THE INVENTION

According to the present invention, an apparatus for supporting a laptop computer includes a tray having a generally T-shaped handle attached to a generally rectangular support body.

The apparatus body has a pair of spaced apart longer parallel side rails connected by a bottom rail and a top rail. The bottom rail is generally planar to provide a resting surface for a front edge of a computer.

The apparatus top rail has a pair of friction means mounted thereon and the handle has a stem attached to the top rail between the friction means. The stem is attached to a cross-bar having a pair of friction means mounted thereon.

A method of using the apparatus according to the present invention wherein a roll-aboard luggage bag has an extending handle assembly formed with a handle attached between a pair of extendable legs whereby when the handle assembly is extended, the friction means contact opposite sides of the legs to maintain the tray in any selected position along the legs.

In another embodiment, the apparatus top rail has a friction means mounted thereon. The handle has a cross-bar attached to the top rail by a pair of legs and the cross-bar has a friction means mounted thereon.

A method of using the apparatus according to the alternate embodiment of the present invention wherein a roll-aboard luggage bag has an extending handle assembly formed with a handle attached between a pair of extendable legs whereby when the handle assembly is extended, the friction means contact opposite sides of the handle assembly legs to maintain the tray in any selected position along the handle assembly legs.

The invention includes an apparatus for supporting a laptop computer comprising: a generally rectangular support body having a pair of spaced apart longer parallel side rails connected by a bottom rail and a top rail, said bottom rail extending above a plane of said side rails to form a support surface for an object resting on said side rails; and a handle attached to said top rail for releasably engaging an extending handle assembly attached to a roll-aboard luggage bag.

The invention includes an apparatus for supporting a laptop computer comprising: a generally rectangular support body having a pair of spaced apart longer parallel side rails connected by a bottom rail and a top rail connected to said side rails; a fixed jaw attached to said top rail; a threaded rod attached to said fixed jaw; a movable jaw mounted on said rod; and a knob threadably engaging said rod for moving said movable jaw toward said fixed jaw whereby said movable jaw and said fixed jaw engage against a pair of legs of an extending handle assembly attached to a roll-aboard luggage bag for releasably securing the support body to the handle assembly.

The invention includes an apparatus for supporting a laptop computer comprising: a generally rectangular support body having a pair of spaced apart longer parallel side rails connected by a bottom rail and a top rail, said bottom rail extending above a plane of said side rails to form a support surface for an object resting on said side rails; and a handle attached to said top rail for releasably engaging an extending handle assembly attached to a roll-aboard luggage bag, said handle including a fixed jaw attached to said top rail, a threaded rod attached to said fixed jaw, a movable jaw mounted on said rod, and a knob threadably engaging said rod for moving said movable jaw toward said fixed jaw whereby said movable jaw and said fixed jaw selectively engage against a pair of legs of the extending handle assembly attached to the roll-aboard luggage bag for releasably securing the support body to the handle assembly.

### DESCRIPTION OF THE DRAWINGS

The above as well as other advantages of the present invention will become readily apparent to those skilled in the art from the following detailed description of a preferred embodiment when considered in the light of the accompanying drawings in which:

FIG. 1 is a perspective view of two embodiments of a tray apparatus in accordance with the present invention;

FIG. 2 is another perspective view of the trays shown in FIG. 1;

FIG. 3 is a perspective view of one of the trays shown in FIG. 1 mounted on the handle of roll-aboard luggage;

FIG. 4 is another perspective view similar to FIG. 4 showing the roll-aboard luggage;

FIG. 5 is a view similar to FIG. 4 with a laptop computer supported by the tray;

FIG. 6 is a view similar to FIG. 5 showing the tray and computer in use;

FIG. 7 is a view similar to FIG. 1 showing a third embodiment of the tray according to the present invention;

FIG. 8 is a view similar to FIG. 4 showing a fourth embodiment of the tray according to the present invention;

FIG. 9 is a view similar to FIG. 4 showing an option for the tray;

FIG. 10 is a perspective view showing a fifth embodiment of the tray according to the present invention mounted on the handle of roll-aboard luggage with a laptop computer supported by the tray;

FIG. 11 is a perspective view showing the tray and computer of FIG. 10;

FIG. 12 is a perspective view similar to FIG. 11;

FIG. 13 is a perspective view of the adjustable clamping mechanism of the tray shown in

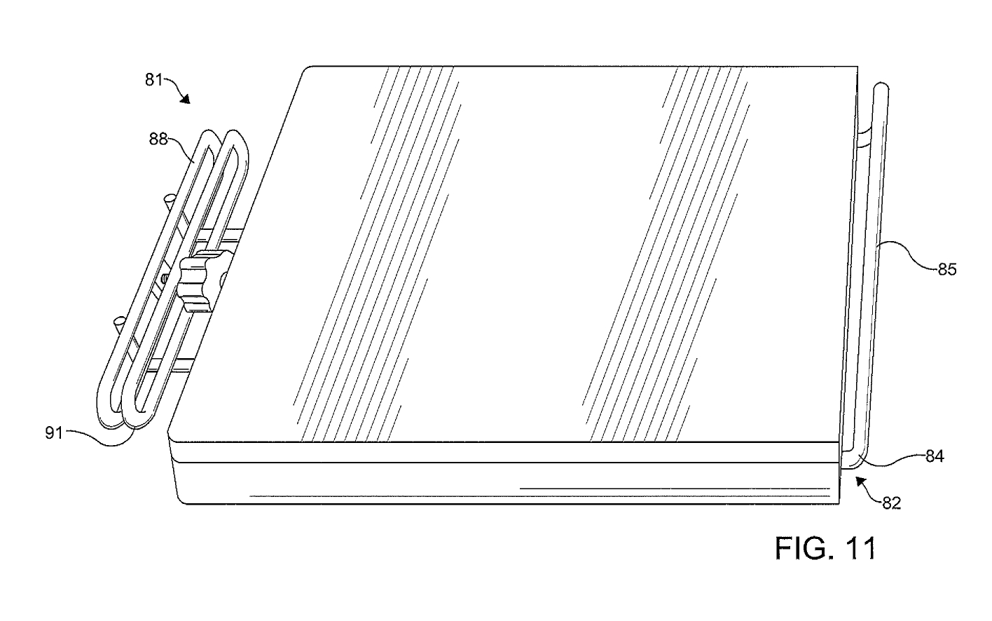

FIG. 10; and

FIG. 14 is a perspective view of the tray shown in FIG. 10 with a laptop computer supported at an angle to a horizontal surface.

### DESCRIPTION OF THE PREFERRED EMBODIMENT

The U.S. provisional patent application Ser. No. 61/292,973 filed Jan. 7, 2010 is hereby incorporated herein by reference.

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

To make the Business traveler's time more productive, a Laptop Tray was invented to easily attach to the handle of roll-aboard luggage and hold a laptop computer at a convenient height in front of the seated user.

The Laptop Tray works on a cantilever principle so when weight is applied to the tray, two rubber coated friction arms rotate to trap the extended luggage handle. The tray's height is adjustable over the length of the vertically extended luggage handle.

The friction arms come in two configurations. (1) A “T” configuration which splits the vertical telescoping handle supports and (2) a “D” configuration which encircles the telescoping handle support rod(s). A low tension bungee cord is recommended to maintain positive downward force on the tray insuring engagement of the friction arms.

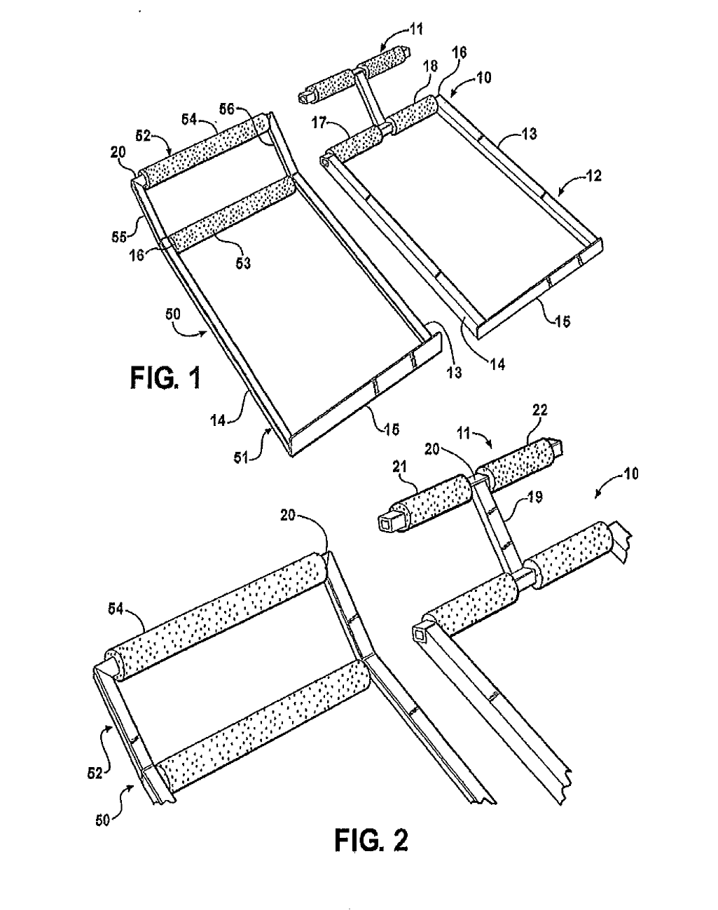

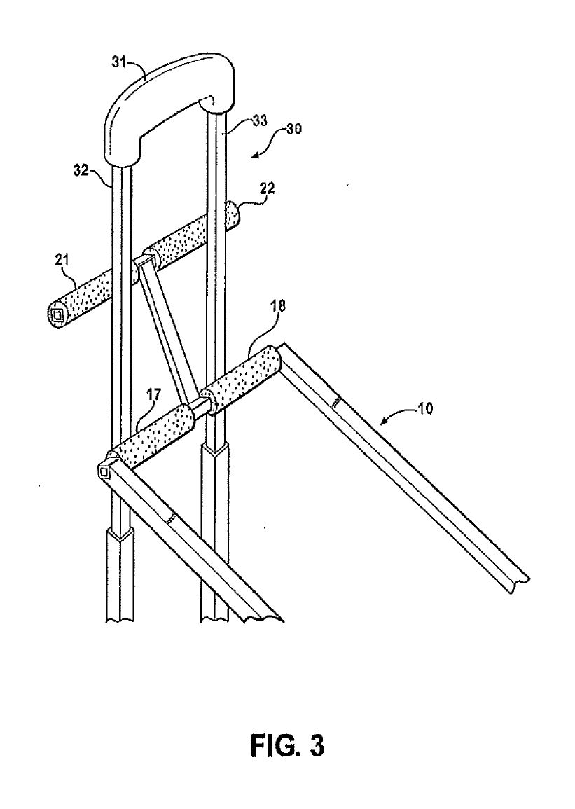

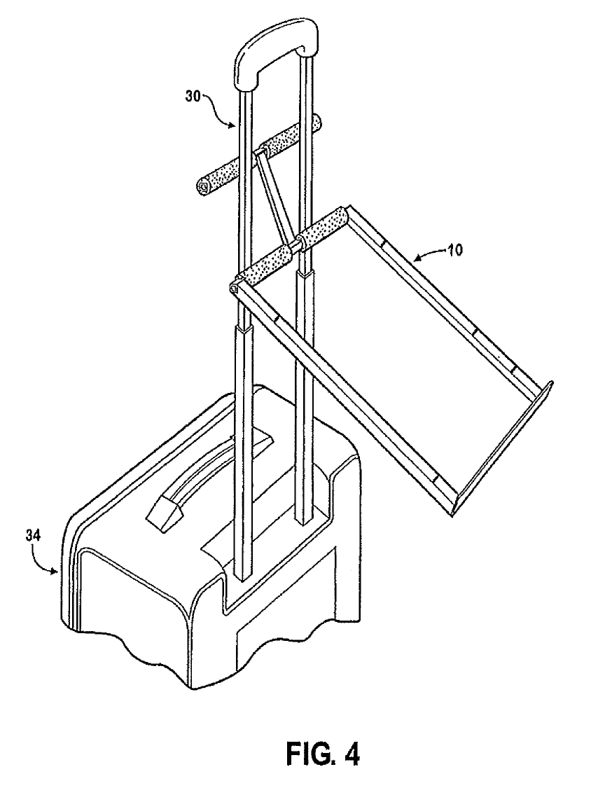

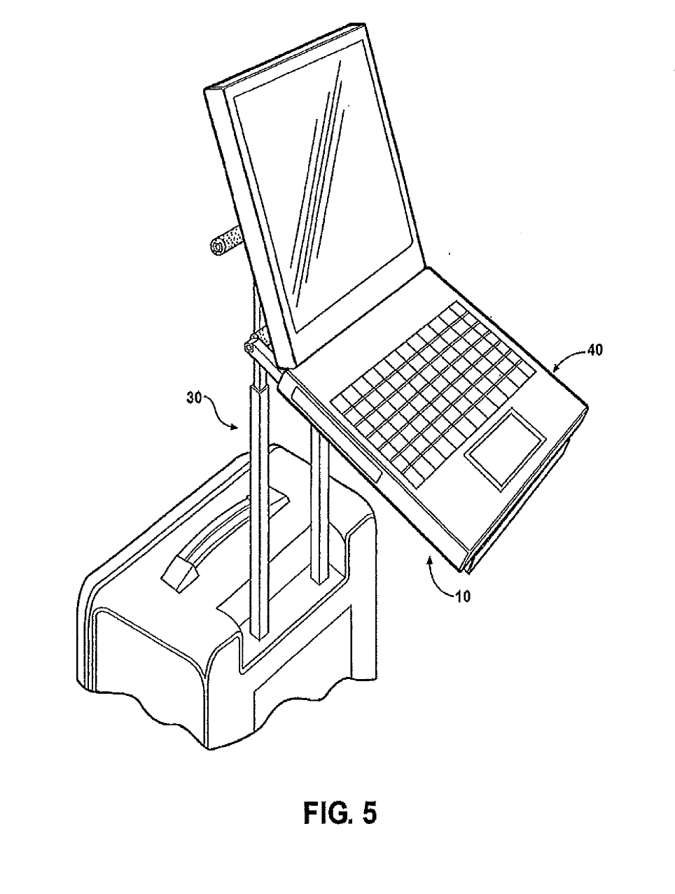

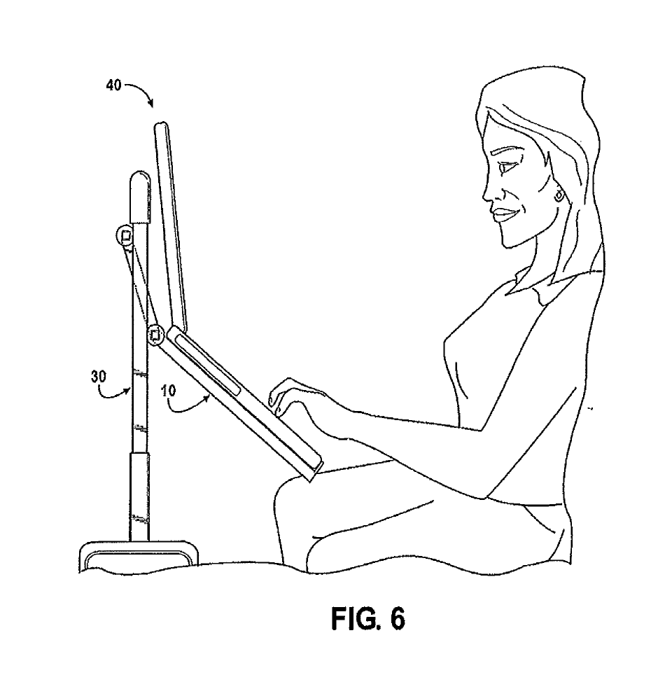

As shown in the FIGS. 1-6 and 9, a tray 10 has a generally T-shaped handle 11 attached to a generally rectangular support body 12. The body 12 has a pair of spaced apart longer parallel side rails 13 and 14 connected by a bottom rail 15 and a top rail 16. The bottom rail 15 is generally planar to provide a resting surface for the front edge of a computer 40. The top rail 16 has a pair of friction devices or means 17 and 18 mounted thereon and the handle 11 has a stem 19 attached to the top rail 16 between the friction means. The stem 19 is attached to a cross-bar 20 having a pair of friction devices or means 21 and 22 mounted thereon. In an alternate embodiment (not shown), the stem 19 can be eliminated from the handle 11 and the cross-bar 20 attached to the top rail 16 by a leg at each end.

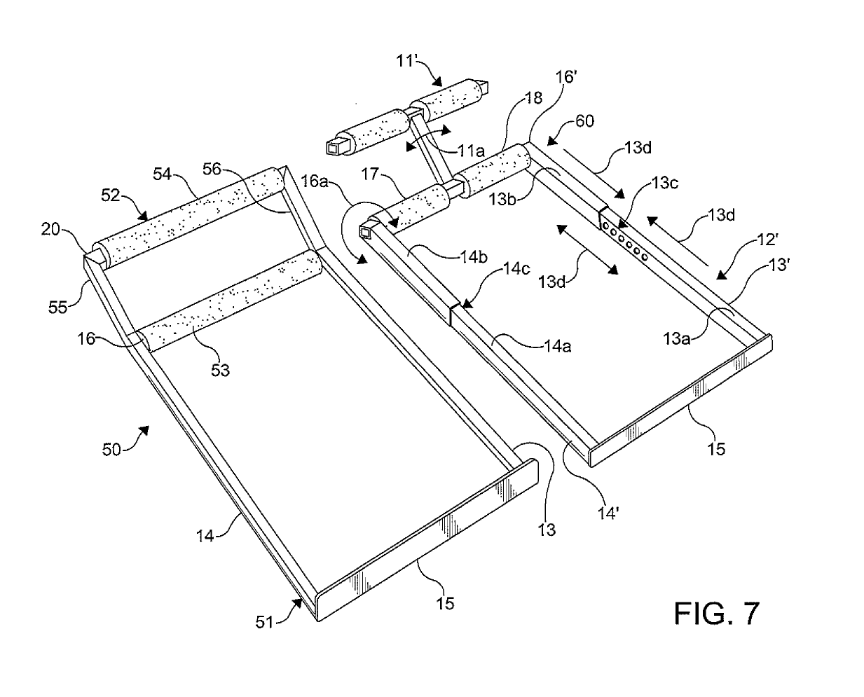

A roll-aboard luggage bag 34 has an extending handle assembly 30 formed with a handle 31 attached between a pair of extendable legs 32 and 33. When the handle assembly 30 is extended, the friction means 17 and 21 contact opposite sides of the leg 32 and the friction means 18 and 22 contact opposite sides of the leg 33 to maintain the tray 10 in any selected position along the legs 32 and 33. When the tray 10 is mounted on the handle assembly 30, the computer 40 can be placed on the rails 13 and 14 to rest against the bottom rail 15. Now the computer 40 is ready for use as shown in FIG. 6.

An alternate embodiment tray 50 has a generally D-shaped handle 52 attached to a generally rectangular support body 51. The body 51 has the pair of spaced apart longer parallel side rails 13 and 14 connected by the bottom rail 15 and the top rail 16. The bottom rail 15 is generally planar to provide a resting surface for the front edge of the computer 40. The top rail 16 has a single friction device or means 53 mounted thereon and the handle 52 has the cross-bar 20 attached to the top rail 16 at the ends thereof by a pair of legs 55 and 56. The cross-bar 20 has a friction device or means 54 mounted thereon.

When the handle assembly 30 of the roll-aboard luggage bag 34 is extended, the legs 55 and 56 cam be placed on opposite sides of the handle assembly 30 and the friction means 53 and 54 will contact opposite sides of the legs 32 and 33 to maintain the tray 50 in any selected position along the legs 32 and 33. When the tray 50 is mounted on the handle assembly 30, the computer 40 can be placed on the rails 13 and 14 to rest against the bottom rail 15 in the manner shown in FIG. 6.

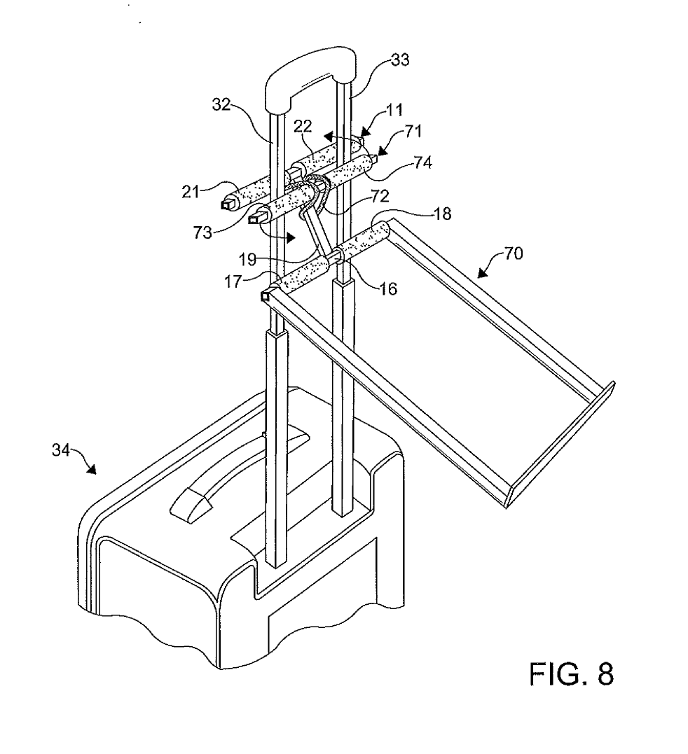

As shown in FIG. 7, a tray 60 has a generally T-shaped handle 11′ attached to a generally rectangular support body 12′ similar to the tray 10 shown in FIG. 1. The body 12′ has a pair of spaced apart longer parallel side rails 13′ and 14′ connected by the bottom rail 15 and the top rail 16′. The side rails 13′ and 14′ are telescoping with bottom sections 13a and 14a respectively into which top sections 13b and 14b slide respectively. The side rails 13′ and 14′ are provided with a locking means 13c and 14c respectively for selectively and releasably maintaining the top and bottom sections in a plurality of relative positions. For example, the locking means 13c and 14c respectively can include a plurality of apertures spaced along the bottom sections 13a and 14a cooperating with a spring biased pin in each of the top sections 13b and 14b. The pins and the apertures cooperate to permit selective relative movement to adjust the distance between the bottom rail 15 and the top rail 16′ as shown by the arrows 13d adjacent the side rail 13′ (FIG. 7).

The top rail 16′ can be mounted on the side rails 13′ and 14′ for rotation about its longitudinal axis as shown by an arrow 16a in FIG. 7. This movement permits changing the angle (arrow 11a) at which the handle 11′ is positioned relative to the plane of the support body 12′. Either the entire top rail 16′ can rotate, or a center section to which the handle 11′ is attached can rotate relative to fixed ends. In either case, a conventional ratchet mechanism can be used to releasably retain the handle 11′ at the selected angle. Thus, the handle 11′ can be rotated in a clockwise direction to position it between the side rails 13′ and 14′, and the side rails 13′ and 14′ can be adjusted to the shortest length for compact storage of the tray 60.

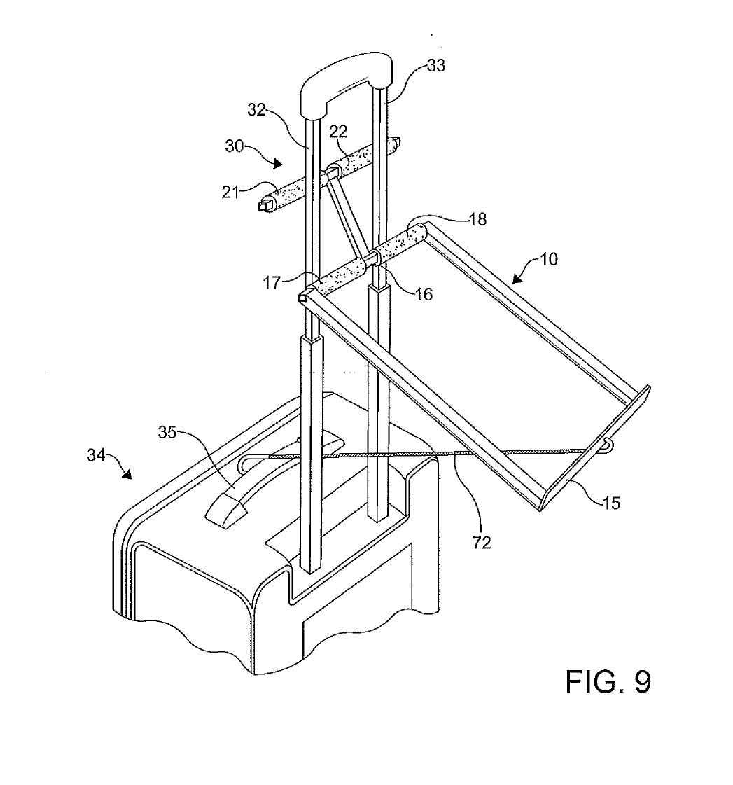

There is shown in FIG. 8 a tray 70 similar to the tray 10, but having two additional elements. When the friction means 17 and 21 contact opposite sides of the leg 32 and the friction means 18 and 22 contact opposite sides of the leg 33, a friction foot 71 can be used in conjunction with an elastic cord 72 to provide tension and function as a hinge. The friction foot 71 is a bar or rod having friction means 73 and 74 engaging the legs 32 and 33 respectively opposite the friction means 21 and 22 respectively. The cord 72 wraps partially around the stem 19 of the handle 11 and partially around the friction foot 71 to tension the friction foot against the legs 32 and 33, and also functions as a hinge permitting the tray 70 to rotate about the longitudinal axis of the top rail 16.

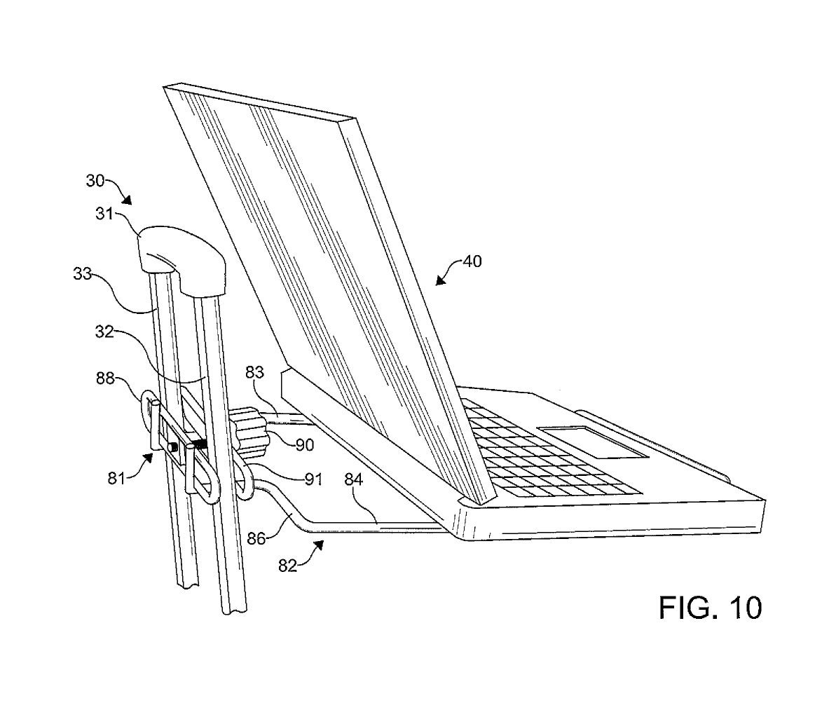

The elastic cord 72 also can be used to secure the tray 10 in place on the handle assembly 30. As shown in FIG. 9, one end of the cord 72 is releasably secured to the bottom rail 15 and an opposite end of the cord is releasably secured to a carrying handle 35 of the roll-aboard luggage bag 34. The length of the cord 72 is selected to apply a tension force to maintain the friction means 17 and 21 in contact with opposite sides of the leg 32 and the friction means 18 and 22 in contact with opposite sides of the leg 33.

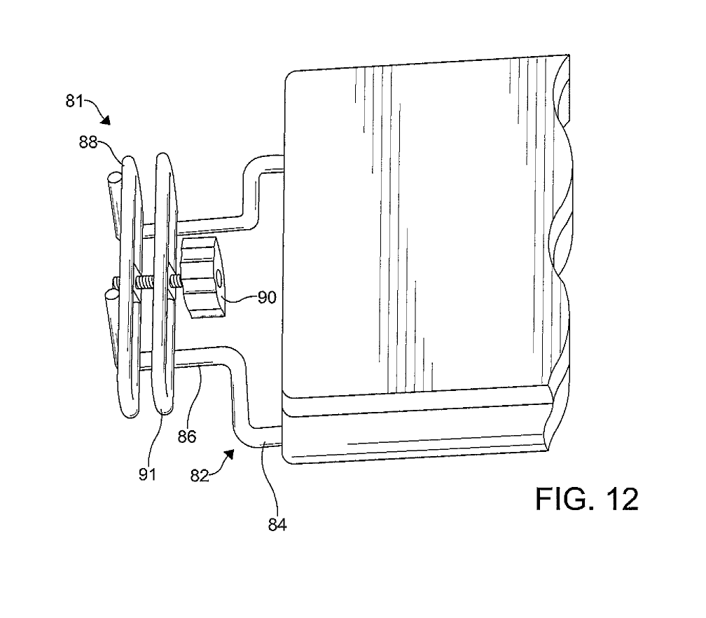

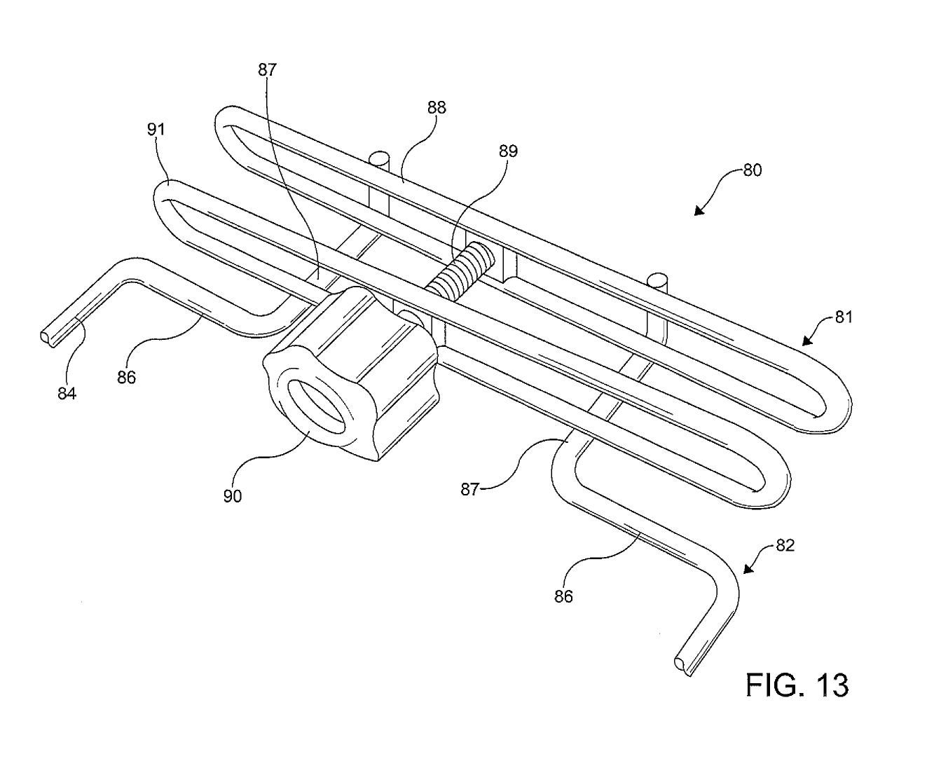

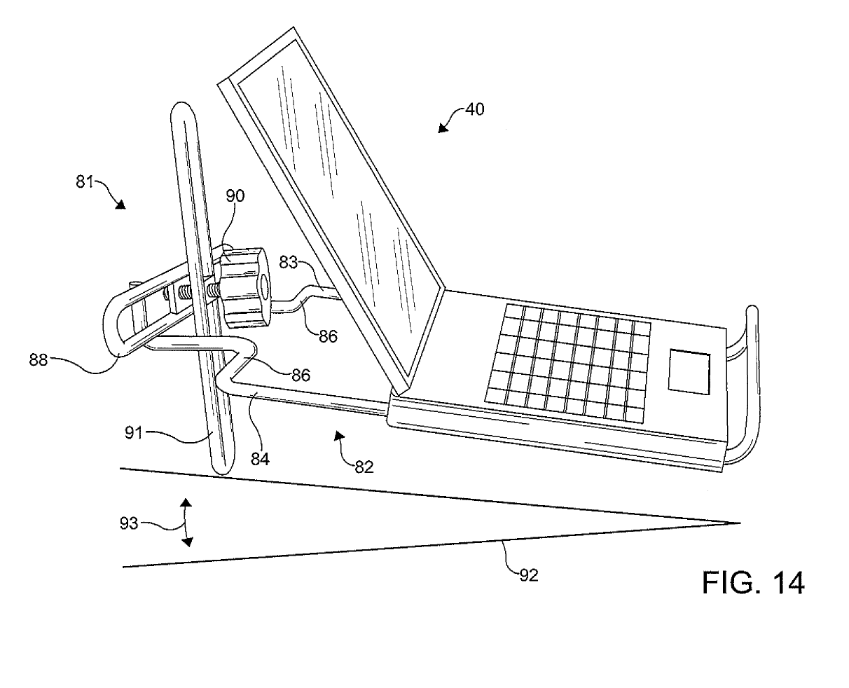

As shown in the FIGS. 10-14, a tray 80 has an adjustable clamping mechanism 81 attached to a generally rectangular support body 82 formed from a wire. The body 82 has a pair of spaced apart longer parallel side rails 83 and 84 connected by a bottom rail 85 and a split top rail 86. The ends of the side rails 83 and 84 connected to the bottom rail 85 are bent to position the bottom rail above a plane of the side rails to provide a resting surface for the front edge of the computer 40. The top rail 86 is split in a central area and free ends 87 extend away from the bottom rail 85 and then bend in the same direction as the opposite ends of the side rails 83 and 84.

Attached to the free ends 87 is a fixed jaw 88 of the clamping mechanism 81. The fixed jaw 88 is formed of wire in a generally rectangular shape with straight long sides and curved short sides and extends in a plane perpendicular to the plane of the side rails 83 and 84. A threaded rod 89 has one end mounted on the fixed jaw 88 at the center thereof and extends between the free ends 87. An internally threaded knob 90 engages the threaded rod 89 whereby the knob can be rotated toward and away from the fixed jaw 88. A movable jaw 91 is formed of wire in the same shape as the fixed jaw 88. The rod 89 extends through an open center of the jaw 91 to position the movable jaw 91 between the fixed jaw 88 and the knob 90.

With the knob 90 and the movable jaw 91 positioned at the free end of the rod 89, the tray 80 can be oriented in a vertical plane to pass the fixed jaw 88 between the legs 31 and 32 of the handle assembly 30 and then rotated in the opposite direction to a horizontal plane as shown in FIG. 10. Next, the knob 90 is rotated to engage the jaws 88 and 91 with the legs 31 and 32 to clamp the tray 80 in place for holding the computer 40.

As shown in FIG. 14, the tray 80 also can be used to support the computer 40 on a horizontal surface. The movable jaw 91 is rotated 90° and clamped against the fixed jaw 88 by the knob 90. With the bottom ends of the side rails 83 and 84 resting on the horizontal surface 92, the jaw 91 functions as a leg to position the computer 40 at an angle 93 toward the user. The angle can be selected by positioning the rod 89 relative to the curved ends of the movable jaw 91 prior to tightening the knob 90.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An apparatus for supporting a laptop computer comprising:
a generally rectangular support body having a pair of spaced apart longer parallel side rails connected by a bottom rail and a top rail, said bottom rail extending above a plane of said side rails to form a support surface for an object resting on said side rails; and
a handle attached to said top rail for releasably engaging an extending handle assembly attached to a roll-aboard luggage bag.

2. The apparatus according to claim 1 wherein said side rails are telescopically adjustable to selectively adjust a distance between said bottom rail and said top rail.

3. The apparatus according to claim 2 including locking means for selectively fixing a plurality of lengths of said side rails.

4. The apparatus according to claim 1 wherein said handle pivots with respect to the plane of said side rails.

5. The apparatus according to claim 1 including a friction foot and an elastic cord, said elastic cord cooperating with and tensioning said handle and said friction foot into engagement against a pair of legs of the extending handle assembly attached to the roll-aboard luggage bag.

6. The apparatus according to claim 1 including an elastic cord having one end releasably attached to said bottom rail and an opposite end configured to be releasably attached to a carrying handle of the roll-aboard luggage bag.

7. The apparatus according to claim 1 wherein said handle includes a fixed jaw attached to said top rail, a threaded rod attached to said fixed jaw, a movable jaw mounted on said rod, and a knob threadably engaging said rod for moving said movable jaw toward said fixed jaw.

8. An apparatus for supporting a laptop computer comprising:
a generally rectangular support body having a pair of spaced apart longer parallel side rails connected by a bottom rail and a top rail connected to said side rails;
a fixed jaw attached to said top rail;
a threaded rod attached to said fixed jaw;
a movable jaw mounted on said rod; and
a knob threadably engaging said rod for moving said movable jaw toward said fixed jaw whereby said movable jaw and said fixed jaw engage against a pair of legs of an extending handle assembly attached to a roll-aboard luggage bag for releasably securing the support body to the handle assembly.

9. The apparatus according to claim 8 wherein said bottom rail extends above a plane of said side rails to form a support surface for an object resting on said side rails.

10. The apparatus according to claim 8 wherein said fixed jaw and said movable jaw are formed from wire.

11. The apparatus according to claim 8 wherein said movable jaw is rotatable on said rod relative to said fixed jaw.

12. An apparatus for supporting a laptop computer comprising:
a generally rectangular support body having a pair of spaced apart longer parallel side rails connected by a bottom rail and a top rail, said bottom rail extending above a plane of said side rails to form a support surface for an object resting on said side rails; and
a handle attached to said top rail for releasably engaging an extending handle assembly attached to a roll-aboard luggage bag, said handle including a fixed jaw attached to said top rail, a threaded rod attached to said fixed jaw, a movable jaw mounted on said rod, and a knob threadably engaging said rod for moving said movable jaw toward said fixed jaw whereby said movable jaw and said fixed jaw selectively engage against a pair of legs of the extending handle assembly attached to the roll-aboard luggage bag for releasably securing the support body to the handle assembly.

13. The apparatus according to claim 12 wherein said movable jaw is rotatable on said rod relative to said fixed jaw.

14. apparatus according to claim 12 wherein said movable jaw has a long side connected to a shorter side, said long side being positioned generally parallel to the plane of the side rails when said movable jaw engages the pair of legs of the extending handle assembly.

15. The apparatus according to claim 14 wherein said movable jaw is rotatable on said rod relative to said fixed jaw to a position wherein said long side extends traverse to the plane of the side rails and said movable jaw functions as a leg with the plane of the side rails being positioned at an angle relative to a horizontal surface on which the apparatus rests.

16. The apparatus according to claim 15 wherein said movable jaw is movable on said rod relative along said long side to adjust a height of the leg.

17. The apparatus according to claim 12 wherein said side rails, said bottom rail and said top rail are formed from a single piece of wire.

18. The apparatus according to claim 12 wherein said top rail is split in a central area to form a pair of free ends extending away from said bottom rail and being attached to said fixed jaw.

19. The apparatus according to claim 12 wherein said fixed jaw and said movable jaw are each formed from a single piece of wire.
